(19) United States
(12) Patent Application Publication
(10) Pub. No.: US 2019/0370865 A1
(43) Pub. Date: Dec. 5, 2019

(54) METHOD AND DEVICE OF APPEALING TO CUSTOMER SMARTLY

(71) Applicant: THE WONDERFUL CREATIVE COMPANY, Taipei City (TW)

(72) Inventor: Jia Ming SHYU, Taichung City (TW)

(21) Appl. No.: 15/991,353

(22) Filed: May 29, 2018

(51) Int. Cl. G06Q 30/02; G10L 15/00; G06K 9/00

(52) U.S. Cl. CPC G06Q 30/0269; G06Q 30/0281; G06K 9/00302; G10L 15/005; G06K 9/00369; G06Q 30/0276

(57) ABSTRACT

A method of appealing to customers smartly includes the steps of: choosing from a crowd a potential target customer with greatest customer characteristic compliance; attracting attention from the target customer by a light ray, image, and/or voice; capturing the target customer' images and synthesizing a 3D human image; retrieving goods images and applying them to the 3D human image to synthesize a composite image; displaying the composite image on a display screen; capturing an image about a facial expression or gesture of the target customer watching the composite image and ranking the goods images by the target customer's preference for the goods images; replacing less preferred ones of the goods images with others; and playing an invitation video or audio when a proportion of the preferred ones of the goods images among the retrieved goods images exceeds a predetermined value. A device for implementing the method is further provided.

### BACKGROUND OF THE INVENTION

### 1. Technical Field

The present disclosure relates to multimedia devices and, more particularly, to a multimedia advertisement-based device and method of appealing to customers.

### 2. Description of Related Art

To increase revenue, shops must entice customers to come and buy goods. To this end, goods-related advertisements are posted on various media platforms, such as newspapers, TV, and the Internet. The goods-related advertisements incur advertisement design expenses and media service expenses. However, seldom located around an advertising scene, the shops are unable to observe responses of customers watching the advertisements. As a result, the shops cannot instantly revise the contents of any advertisement which fails to attract customers, and in consequence the uninterested customers are leaving. Even if customers are interested in an advertisement, the odds are that the customers will be reluctant to visit the shops because the shops are not in the vicinity of the advertising scene, and in consequence the shops lose the customers.

Another conventional mode of advertising involves handing out flyers, samples, and gifts on the street. It incurs costs in the production of the flyers, samples, and gifts and workers' wages. Its advantage is: in addition to the goods per se, personal interactions have an advertising effect. However, the aforesaid personal interactions alter for various reasons and depend on psychological states of the persons concerned. As a result, there is no guarantee that the advertising effect will be satisfactory and thus cost-effective.

Furthermore, when badly designed, the conventional mode of advertising fails to attract customers, causing the customers to leave immediately. As a result, not only are the flyers, samples, and gifts handed out in vain, but the reasons why the customers are not visiting the shops also remain unidentified, and in consequence the shops cannot learn from failures and make improvements.

### BRIEF SUMMARY OF THE INVENTION

It is an objective of the present disclosure to provide a method and device of appealing to customers smartly, using multimedia to produce and present 3D images of pedestrians passing the door of a shop and displaying goods which match the 3D images, so as to induce a desirable psychological state of the pedestrians, such as curiosity, astonishment or admiration, with a view to boosting the chance that the pedestrians will buy the goods.

In order to achieve the above and other objectives, the present disclosure provides a method of appealing to customers smartly, the method being implemented near a shop and comprising the steps of:

choosing from a crowd a potential target customer with a highest degree of customer characteristic compliance;

attracting attention from the target customer by a light ray, an image, a voice or a combination of at least two thereof;

capturing an image of the target customer and synthesizing a 3D human image;

retrieving appropriate goods images and applying the retrieved goods images to the 3D human image to synthesize a composite image;

displaying the composite image on a display screen;

capturing an image about a facial expression or a gesture of the target customer watching the composite image and ranking the goods images by the target customer's preference for the goods images;

replacing less preferred ones of the goods images with the other goods images according to the ranking; and

playing an invitation video or audio when a proportion of the preferred ones of the goods images among all the retrieved goods images exceeds a predetermined value.

In an embodiment, the method further comprises modifying the 3D human image by a means of modification.

In an embodiment, the method further comprises recording characteristics of

visiting customers for use in comparison in the step of choosing a potential target customer from the crowd.

In an embodiment, the method further comprises recording characteristics of non-visiting customers who have watched the composite image and ranking the goods images by the non-visiting customer's preference for the goods images.

In an embodiment, the method further comprises capturing a voice of the target customer, identifying a language of the voice, and producing an invitation video or audio in the language.

In an embodiment, the method further comprises going back to the step of choosing the potential target customer from the crowd when the proportion of the preferred ones of the goods images among all the retrieved goods images has not exceeded the predetermined value for a time period.

The present disclosure further provides a device of appealing to customers smartly, the device being applicable to the method and comprising:

a central processing unit having a customer characteristics database, a goods database, a calculation unit and an image synthesis unit;

a multimedia playing apparatus for playing a light ray, an image, a voice or a combination of at least two thereof to attract attention from a crowd;

an image capturing apparatus electrically connected to the central processing unit to capture images of the crowd and send the images to the central processing unit, wherein the calculation unit compares the images with the customer characteristics database to identify a potential target customer with a highest degree of customer characteristic compliance, the image synthesis unit synthesizes a 3D human image from the target customer's images, the calculation unit retrieves appropriate goods images from the goods database, and the image synthesis unit synthesizes a composite image from the goods images and the 3D human image;

a display screen electrically connected to the central processing unit to display the composite image and play an invitation video or audio; and

a monitoring apparatus electrically connected to the central processing unit to capture a monitoring image about a facial expression or a gesture of the target customer watching the composite image and send the monitoring image to the central processing unit such that the calculation unit ranks the goods images by the target customer's preference for the goods images according to the monitoring image and then replaces less preferred ones of the goods images with the other goods images.

In an embodiment, the multimedia playing apparatus is located near a shop, the image capturing apparatus is located near the multimedia playing apparatus, and the display screen is located near a door of the shop.

In an embodiment, the image synthesis unit is capable of modifying the 3D human image.

In an embodiment, the image capturing apparatus receives and records voice-related information, whereas the calculation unit identifies a language according to the voice-related information and produces an invitation video or audio in the language.

In an embodiment, the calculation unit analyzes the crowd images captured by the image capturing apparatus to identify characteristics of visiting customers and records the identified characteristics of the visiting customers in the customer characteristics database.

In an embodiment, the calculation unit analyzes the crowd images captured by the image capturing apparatus to identify characteristics of non-visiting customers who have watched the composite image, rank the goods images by the non-visiting customer's preference for the goods images, and record the rankings in the customer characteristics database.

In an embodiment, the image synthesis unit has an output unit for outputting a file of the composite image.

### BRIEF DESCRIPTION OF THE SEVERAL VIEWS OF THE DRAWINGS

FIG. 1 is a schematic view of the process flow of a method of appealing to customers smartly according to an embodiment of the present disclosure;

FIG. 2 is a perspective view of a device of appealing to customers smartly according to an embodiment of the present disclosure; and

FIG. 3 is a block diagram of the device of appealing to customers smartly according to an embodiment of the present disclosure.

### DETAILED DESCRIPTION OF THE INVENTION

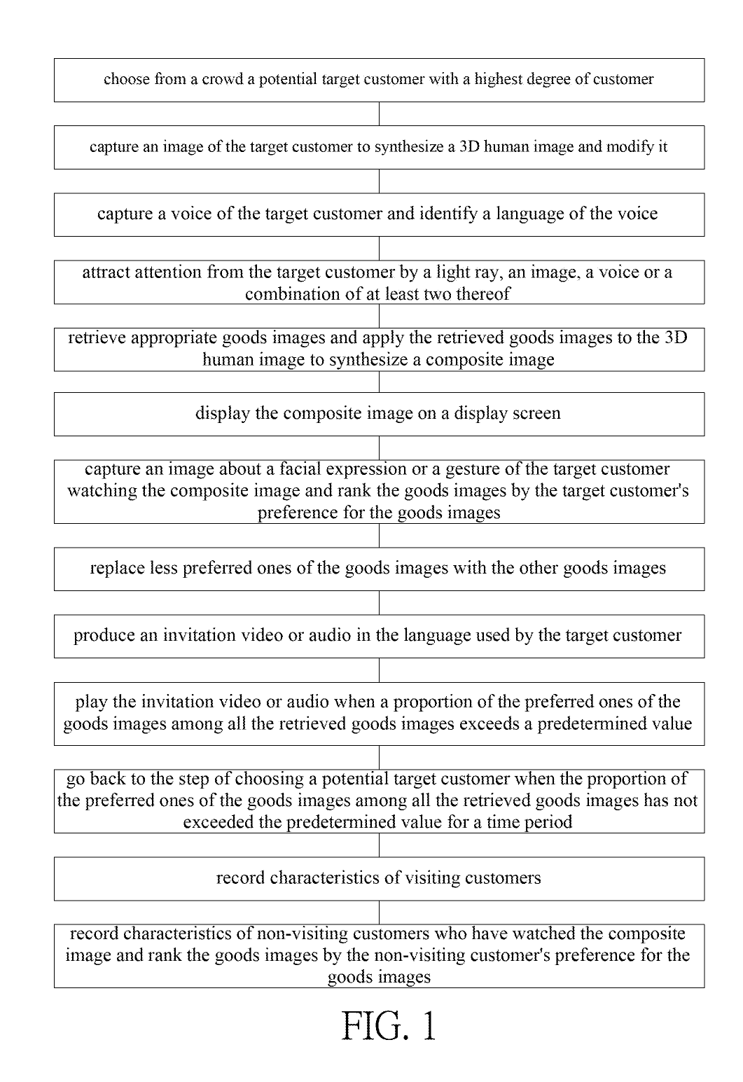

Referring to FIG. 1, the present disclosure provides a method of appealing to customers smartly. The method is implemented near a shop. The method comprises the steps of:

choosing from a crowd a potential target customer with a highest degree of customer characteristic compliance;

attracting attention from the target customer by a light ray, an image, a voice or a combination of at least two thereof;

capturing an image of the target customer to synthesize a 3D human image and modify it;

capturing a voice of the target customer and identifying a language used by the target customer;

retrieving appropriate goods images and apply the retrieved goods images to the 3D human image to synthesize a composite image;

displaying the composite image on a display screen;

capturing an image about a facial expression or a gesture of the target customer watching the composite image and ranking the goods images by the target customer's preference for the goods images;

replacing less preferred ones of the goods images with the other goods images according to the ranking;

producing an invitation video or audio in the language used by the target customer;

playing the invitation video or audio when a proportion of the preferred ones of the goods images among all the retrieved goods images exceeds a predetermined value;

going back to the step of choosing the potential target customer from the crowd when the proportion of the preferred ones of the goods images among all the retrieved goods images has not exceeded the predetermined value for a time period;

recording characteristics of visiting customers; and

recording characteristics of non-visiting customers who have watched the composite image and ranking the goods images by the non-visiting customer's preference for the goods images.

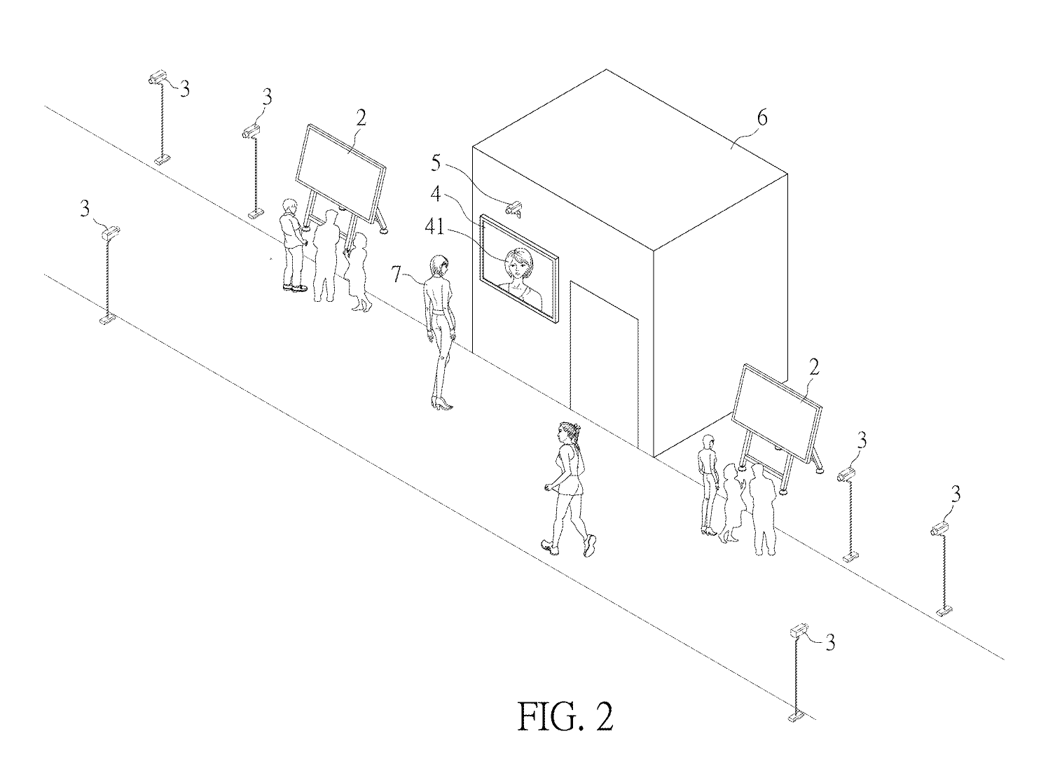

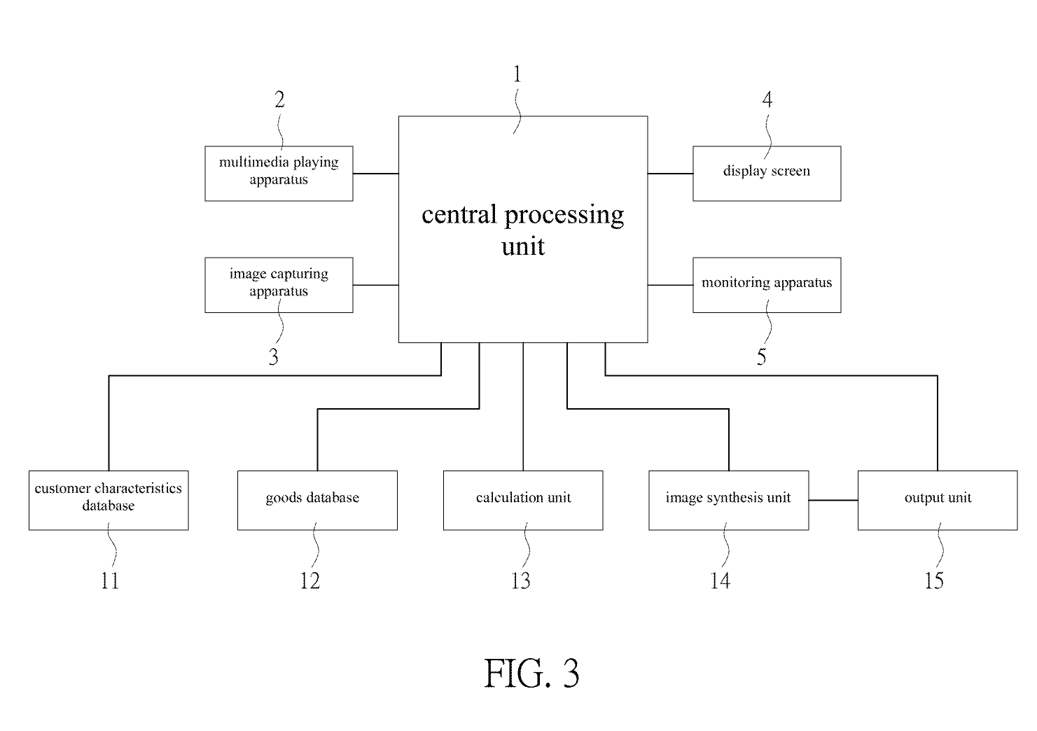

Referring to FIGS. 2, 3, the present disclosure further provides a device of appealing to customers smartly. The device is applicable to the method. The device comprises a central processing unit (CPU) 1, a multimedia playing apparatus 2, an image capturing apparatus 3, a display screen 4 and a monitoring apparatus 5. The central processing unit 1 has a customer characteristics database 11, a goods database 12, a calculation unit 13 and an image synthesis unit 14.

As shown in FIG. 2, a shop 6 installed with the device of the present disclosure is surrounded by a wired or wireless communication network. The multimedia playing apparatus 2 is located near the shop 6 and is a lamp, an audio player or a display screen to not only play a multimedia file including a light ray, an image, a voice or a combination of at least two thereof but also attract attention from a crowd and cause the crowd to gather together—the purposes of advertisements. The image capturing apparatus 3 is located near the multimedia playing apparatus 2 and comprises a plurality of camcoders adapted to capture images and voice-related information and connected to the central processing unit 1 by the communication network, so as to capture images and voices of the crowd which gather together at the multimedia playing apparatus 2 and then send the images and voices to the central processing unit 1. In this embodiment, the image capturing apparatus 3 is in the number of three, not only implemented as three camcoders, but also located at three vertices of a triangle in front of the multimedia playing apparatus 2, respectively.

After the crowd's images captured by the image capturing apparatus 3 have been sent to the central processing unit 1, the calculation unit 13 compares the images with the customer characteristics database 11 to identify a potential target customer 7 with a highest degree of customer characteristic compliance. Various customer data, including past transaction data and information pertaining to characteristics of deep-pocketed persons, are stored in the customer characteristics database 11 so as to be updated and supplemented continually because of accumulation of transaction data.

Upon identification of a target customer 7, the image synthesis unit 14 synthesizes a 3D human image from images previously captured by the image capturing apparatus 3 and modifies the 3D human image by a means of modification, for example, beautifying a human being's skin or changing various artistic styles. Afterward, the calculation unit 13 retrieves appropriate goods images, such as those of clothing, pants, hats, and ornaments, from the goods database 12. Then, the image synthesis unit 14 synthesizes a composite image 41 from the goods images and the 3D human image. The goods database 12 contains image data related to various goods sold at the shop 6. The calculation unit 13 selects goods images which match the 3D human image and then retrieves the selected goods images from the goods database 12.

Upon completion of its synthesis, the composite image 41 is displayed on the display screen 4 and browsed by the target customer 7 and the general public. In this embodiment, the display screen 4 is located near the door of the shop 6 such that people interested in the composite image 41 can gain access to the shop 6 easily.

As soon as the attention of the target customer 7 is drawn to the multimedia playing apparatus 2 and thus the target customer 7 lingers at the multimedia playing apparatus 2, images of the target customer 7 are synthesized as the composite image 41 to be displayed on the display screen 4. Hence, the target customer 7 immediately notes that the display screen 4 shows a figure that looks like herself/himself and thus gets so emotional, for example, curious or astonished, that s/he approaches the display screen 4 (i.e., near the door of the shop 6). Afterward, the target customer 7 discovers that a garment, pants, hat or ornament worn by the figure in the composite image 41 is different from, but more elegant, beautiful, fashionable and popular than, hers/his; hence, the target customer 7 becomes more emotional, for example, aggressive, overly proud, jealous, or agreeable, thereby increasing her/his chance of visiting the shop 6.

A monitoring apparatus 5 is located in the vicinity of the display screen 4 and connected to the central processing unit 1 by the communication network to capture a monitoring image about a facial expression or a gesture of the target customer 7 watching the display screen 4. The target customer 7 watching the display screen 4 may have emotions, for example, being satisfied or dissatisfied with the goods shown in the composite image 41. The emotions are usually manifested as a facial expression or a gesture whose images are then captured by the monitoring apparatus 5 and sent to the central processing unit 1. Afterward, if the calculation unit 13 determines, according to the monitoring image and thus in accordance with the degree of preference of the target customer 7 for the goods images, that the target customer 7 is dissatisfied with a certain item of goods, the calculation unit 13 will replace the item of goods with another and synthesize a new composite image 41 anew. The more satisfied the target customer 7 is with the composite image 41, the more emotional, that is, aggressive, overly proud, jealous, or agreeable, the target customer 7 is, thereby increasing her/his chance of visiting the shop 6.

The image synthesis unit 14 has an output unit 15 for outputting a file of the composite image 41 to the general public. The output unit 15 is a photo printer or a computer's USB port for outputting the composite image 41 in the form of a photo or an electronic file to facilitate shopping by the general public.

The display of the composite image 41 (and thus the gesture therein) on the display screen 4 lasts for a time period. The length of the time period depends on foot traffic. The heavier the foot traffic is, the shorter the time period is. The time period sees the continuation of the gesture attributed to the target customer 7 and associated with the preference of the target customer 7 for the goods images as analyzed by the calculation unit 13. When the time period ends, if the calculation unit 13 determines that the target customer 7 is satisfied with most of the goods images, that is, a proportion of the preferred goods images among all the retrieved goods images exceeds a predetermined value, the calculation unit 13 will instruct the display screen 4 to play an invitation video or audio to further urge the target customer 7 to visit the shop 6. With the display screen 4 being located near the door of the shop 6, there is a good chance that the target customer 7 will go into the shop 6 upon invitation.

The invitation video or audio is produced by the calculation unit 13 in a language commonly used by the target customer 7. The commonly-used language is determined according to the voice-related information attributed to the target customer 7 and received/recorded by the image capturing apparatus 3. The production of the invitation video or audio in a language commonly used by the target customer 7 is conducive to enhancement of intimacy and an increase in the chance that the target customer 7 will accept the invitation.

When the time period during which the composite image 41 is displayed on the display screen 4 ends, if the calculation unit 13 determines that the proportion of the preferred goods images among all the retrieved goods images is less than the predetermined value, the calculation unit 13 will ignore the target customer 7 and start looking for a new target customer from the crowd's images captured by the image capturing apparatus 3, that is, repeating the aforesaid process flow of the method of the present disclosure.

As indicated above, the composite image 41 has a great advertising effect and thus is effective in increasing the chance that the target customer 7 will go into the shop 6. However, the odds are that the target customer 7 will not go into the shop 6 for any unknown reason, thereby losing the target customer 7. Regarding those customers who go into the shop 6, the shop 6 is equipped with the camcoders for capturing the customers' images so that the calculation unit 13 analyzes their characteristics and record their analyzed characteristics in the customer characteristics database 11. By contrast, the image capturing apparatus 3 captures images of non-visiting customers, and then the calculation unit 13 analyzes their characteristics; then, their analyzed characteristics and their preferences for the goods images are recorded in the customer characteristics database 11. Hence, the contents of the customer characteristics database 11 increase because of accumulation of data, so as to enhance the precision of the subsequent search for target customers and thus increase the number of customers who are going to visit the shop 6.

The present disclosure improves conventional modes of advertising by stimulating audiovisual sensations and emotions of target customers by multimedia and automation so as to attract the target customers, then discerning changes in the customers' facial expressions or gestures smartly, and providing appropriate goods advertisement in diverse, variable ways, with a view to encouraging the customers to visit a shop concerned.

What is claimed is:

1. A method of appealing to customers smartly, comprising the steps of:
choosing from a crowd a potential target customer with a highest degree of customer characteristic compliance;
attracting attention from the target customer by a light ray, an image, a voice or a combination of at least two thereof;
capturing an image of the target customer and synthesizing a 3D human image;
retrieving appropriate goods images and applying the retrieved goods images to the 3D human image to synthesize a composite image;
displaying the composite image on a display screen;
capturing an image about a facial expression or a gesture of the target customer watching the composite image and ranking the goods images by the target customer's preference for the goods images;
replacing less preferred ones of the goods images with the other goods images according to the ranking; and
playing an invitation video or audio when a proportion of the preferred ones of the goods images among all the retrieved goods images exceeds a predetermined value.

2. The method of appealing to customers smartly according to claim 1, wherein the method is implemented near a shop.

3. The method of appealing to customers smartly according to claim 1, further comprising modifying the 3D human image by a means of modification.

4. The method of appealing to customers smartly according to claim 1, further comprising recording characteristics of visiting customers for use in comparison in the step of choosing the potential target customer from the crowd.

5. The method of appealing to customers smartly according to claim 1, further comprising recording characteristics of non-visiting customers who have watched the composite image and ranking the goods images by the non-visiting customer's preference for the goods images.

6. The method of appealing to customers smartly according to claim 1, further comprising capturing a voice of the target customer, identifying a language of the voice, and producing an invitation video or audio in the language.

7. The method of appealing to customers smartly according to claim 1, further comprising going back to the step of choosing the potential target customer from the crowd when the proportion of the preferred ones of the goods images among all the retrieved goods images has not exceeded the predetermined value for a time period.

8. A device of appealing to customers smartly, the device being applicable to the method of claim 1 and comprising:
a central processing unit having a customer characteristics database, a goods database, a calculation unit and an image synthesis unit;
a multimedia playing apparatus for playing a light ray, an image, a voice or a combination of at least two thereof to attract attention from a crowd;
an image capturing apparatus electrically connected to the central processing unit to capture images of the crowd and send the images to the central processing unit, wherein the calculation unit compares the images with the customer characteristics database to identify a potential target customer with a highest degree of customer characteristic compliance, the image synthesis unit synthesizes a 3D human image from the target customer's images, the calculation unit retrieves appropriate goods images from the goods database, and the image synthesis unit synthesizes a composite image from the goods images and the 3D human image;
a display screen electrically connected to the central processing unit to display the composite image and play an invitation video or audio; and
a monitoring apparatus electrically connected to the central processing unit to capture a monitoring image about a facial expression or a gesture of the target customer watching the composite image and send the monitoring image to the central processing unit such that the calculation unit ranks the goods images by the target customer's preference for the goods images according to the monitoring image and then replaces less preferred ones of the goods images with the other goods images.

9. The device of appealing to customers smartly according to claim 8, wherein the multimedia playing apparatus is located near a shop, the image capturing apparatus is located near the multimedia playing apparatus, and the display screen is located near a door of the shop.

10. The device of appealing to customers smartly according to claim 8, wherein the image synthesis unit is capable of modifying the 3D human image.

11. The device of appealing to customers smartly according to claim 8, wherein the image capturing apparatus receives and records voice-related information, whereas the calculation unit identifies a language according to the voice-related information and produces an invitation video or audio in the language.

12. The device of appealing to customers smartly according to claim 8, wherein the calculation unit analyzes the crowd images captured by the image capturing apparatus to identify characteristics of visiting customers and records the identified characteristics of the visiting customers in the customer characteristics database.

13. The device of appealing to customers smartly according to claim 8, wherein the calculation unit analyzes the crowd images captured by the image capturing apparatus to identify characteristics of non-visiting customers who have watched the composite image, rank the goods images by the non-visiting customer's preference for the goods images, and record the rankings in the customer characteristics database.

14. The device of appealing to customers smartly according to claim 8, wherein the image synthesis unit has an output unit for outputting a file of the composite image.
